(19) United States
(12) Patent Application Publication
(10) Pub. No.: US 2016/0335682 A1
(43) Pub. Date: Nov. 17, 2016

(54) Online Brochure Delivery System

(71) Applicant: Impact Marketing Services, LLC, Sevierville, TN (US)

(72) Inventors: Stephen T. Williams, Sevierville, TN (US); Andrew T. Parrott, Knoxville, TN (US); M. Jason Shultz, Sevierville, TN (US)

(73) Assignee: Impact Marketing Services, LLC, Sevierville, TN (US)

(21) Appl. No.: 15/149,403

(22) Filed: May 9, 2016

Related U.S. Application Data
(60) Provisional application No. 62/161,456, filed on May 14, 2015.

(51) Int. Cl. G06Q 30/02; G06F 17/21

(52) U.S. Cl. CPC G06Q 30/0277; G06F 17/212; G06Q 30/0261; G06Q 30/0255; G06Q 30/0276

(57) ABSTRACT

A processor-based system for electronically presenting virtual brochures to a customer. The system has a server with a memory for holding information relating to the brochures. A processor generates a page of selected brochures, and arranges the brochures in tiers on the page. the processor selectively shuffles an order of the brochures within the tiers upon occurrences of generating the page. An output sends the page to a customer device. In this manner, clients of the system can pay to have their brochures in higher, more visible tiers as desired, but each brochure within a given tier is provided with the same visibility as the other brochures within the same tier.

This application claims priority on prior pending U.S. provisional patent application Ser. No. 62/161,456 filed 2015 May 14. This invention relates to the field of advertising. More particularly, this invention relates to delivering online brochures to customers.

### FIELD

### Introduction

Advertisers have been using the Internet and other online systems for many years to promote the sale of goods and services. Tourist development web sites, for example, provide a single source of contact for the presentation of advertisements for many different businesses, such as a chamber of commerce web site providing a web page that advertises for all of its member businesses.

However, location of a given advertisement within the presentation on the web page can have a large effect—positive or negative—upon the effectiveness of the advertisement. Further, the passive nature of a web site that merely displays advertisements, only goes so far in closing a sale to a customer.

What is needed, therefore, is a system that reduces issues such as those described above, at least in part.

### SUMMARY

The above and other needs are met by a processor-based system for electronically presenting virtual brochures to a customer. The system has a server with a memory for holding information relating to the brochures. A processor generates a page of selected brochures, and arranges the brochures in tiers on the page. The processor selectively shuffles an order of the brochures within the tiers upon occurrences of generating the page. An output sends the page to a customer device.

In this manner, clients of the system can pay to have their brochures in higher, more visible tiers as desired, but each brochure within a given tier is provided with the same visibility as the other brochures within the same tier.

In various embodiments, the processor selects the brochures for the created page based at least in part upon a location of the device. In some embodiments, the processor selects the brochures for the created page based at least in part upon a category of brochures selected by the customer. In some embodiments, the processor selects the brochures for the created page based at least in part upon a service level paid for by a brochure sponsor. In some embodiments, the processor selects the brochures for the created page based at least in part upon a history of brochures opened by the customer. In some embodiments, the processor selects the tier in which a brochure is arranged based at least in part upon a service level paid for by a brochure sponsor.

In some embodiments, the processor stores to the memory a number of occurrences that the customer has opened each one of the brochures. In some embodiments, the processor stores to the memory a length of time that the customer has viewed each one of the brochures. In some embodiments, the processor stores to the memory a location of the customer when the customer opened each one of the brochures. In some embodiments, a first set of functions performed by the processor is performed by a first processor disposed in a remote server, and a second set of functions performed by the processor is performed by a second processor disposed in the device of the customer.

According to another aspect of the invention there is described a processor-based method for electronically presenting virtual brochures to a customer, by selecting brochures from a memory with a processor, where each of the brochures have associated with it a tier. In response to a first request, a first page of the brochures is generated by arranging the brochures on the first page according to their associated tier, and in a first order within the tiers. In response to a second request, a second page of the brochures is generated by arranging the brochures on the second page according to their associated tier, and in a second order within the tiers, where the second order is different from the first order. The pages are sent as requested to a customer device.

According to yet another aspect of the invention there is described a software program disposed on a non-volatile medium, where the program is operable to enable a computing device to electronically present virtual brochures to a customer, in the manner as described above and elsewhere herein.

### DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a depiction of a web page with virtual brochures arranged in three tiers according to a first order, according to an embodiment of the present invention.

FIG. 2 is a depiction of a web page with virtual brochures arranged in three tiers according to a second order, according to an embodiment of the present invention.

FIG. 3 is a functional block diagram of a system according to an embodiment of the present invention.

### DESCRIPTION

In some embodiments, the system 100 includes a server 102 connected to a global network such as the Internet. The server 102 is, in various embodiments, at least one of a single computer, several distributed computers, a network of computer, and virtual servers. The server 102 includes digital data memory or access to such, processing capabilities, and interface capabilities, either locally or remotely, such as input, output, and display capabilities. The server 102 also includes programming in the memory, which programming enables the server 102 to accomplish the functions as described herein.

When accessed by a customer device 104, such as through the Internet 110, the server 104 produces web pages that display a selection of advertisements for goods and services that are provided by clients. The clients contract with the owners of the system to have their advertisements, referred to as brochures herein, displayed to customers according to a set of rules by which brochures are selected by the system 100 programming for display in the web pages that are presented to the customers 104. Clients can have their brochures selected for display in a number of different ways—such as frequency of display—based upon the rules that the system 100 uses, and based upon a level of service as contracted with the owners.

The brochures have an initial presentation that looks like a physical brochure on a rack, and which can be interacted with by the customer to provide a wide array of additional information and options. The customer can selectably view categories of the brochures or all of the brochures. The server 102 tracks what the customer interacts with, and identifies the general location of the customer device 104 based on the IP address. Reports are generated indicating how many hits a particular brochure receives, what types of hits occurred, and where the customer device 104 was located. These reports can be provided to the owners and the clients.

In one embodiment, the brochures as presented are divided into at least two tiers. The first tier is always displayed on the uppermost virtual shelves. The second tier is displayed below the first tier. Additional tiers are also comprehended. Each time a customer accesses the brochure rack, such as by initial visit or page revisits or refreshes, the tiers are individually shuffled, in that brochures do not move from one tier to another, but are reorganized within their assigned tier.

Shuffling in some embodiments means a reordering of the brochures within each tier in a random or a pseudorandom manner. A truly random reordering will actually bunch some brochures to the front and some to the rear. That is the nature of a true random pattern. It tends to be irregularly bunched and to favor some brochures over others. Likewise, a pseudorandom algorithm tends to produce results that imitate true random shuffling. So, even pseudorandom algorithms tend to produce bunching and favoritism for particular brochures. Such random or pseudorandom shuffling may be used in some embodiments, but fair shuffling may be used in other embodiments.

Fair shuffling is a type of reordering that ensures some level of fairness to each brochure. So, fair shuffling could include a uniform rotation of the brochures such that each brochure spends the same amount of time in each spot within a tier. Fair shuffling may also include a type of reordering that is somewhat random and appears to be random, but is actually limited by fairness criteria that ensures at least a minimum level of top exposure for each brochure.

For example, a fair shuffle may provide for a totally random shuffle for the first three shuffles, then on the fourth shuffle, only brochures that have not been placed in the top left spot will be eligible for the top left spot, and only brochures that have not been in the second top spot will be eligible for the second top spot, and so on for all spots in the tier. Once a particular spot has had all brochures appear in it, all brochures will be eligible for that particular spot. Once the first, second and third top spots have been filled by all brochures in the tier, the next shuffle is truly random or pseudorandom and all brochures are eligible for all spots again. Then, three shuffles are totally random (or pseudorandom) and the process repeats itself. This particular algorithm will show favoritism to some brochures because it includes a number of random shuffles. However, after three shuffles, the algorithm imposes a fairness criterion and ensures that all brochures will appear at least once in each of the top three spots.

In this manner, each brochure within a tier receives the same or a similar amount of exposure to the customers, has equal opportunity to be listed first within a given tier, on the uppermost shelf of a given tier, or on the first page of a given tier, depending upon the configuration of a given embodiment of the web pages produced by the system 100.

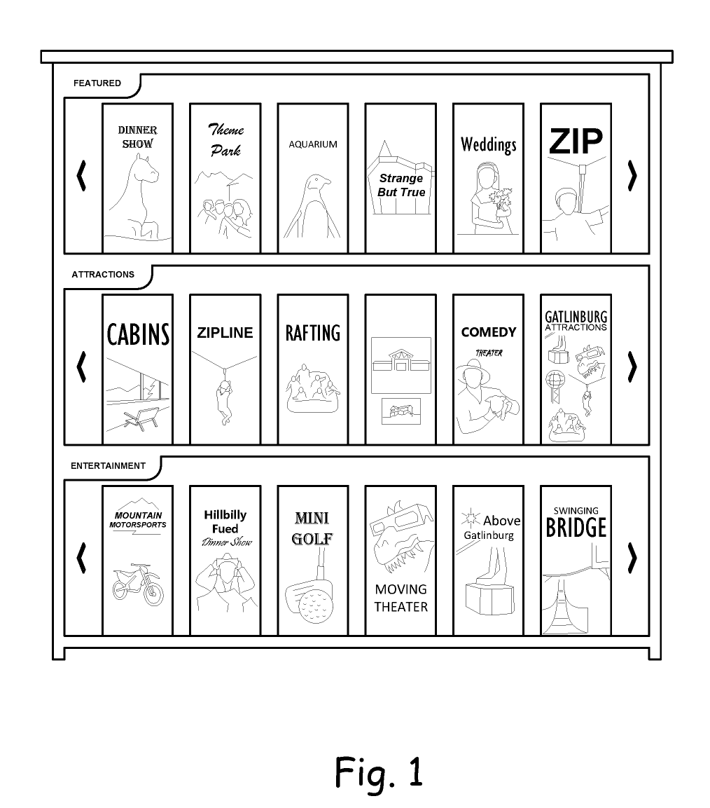

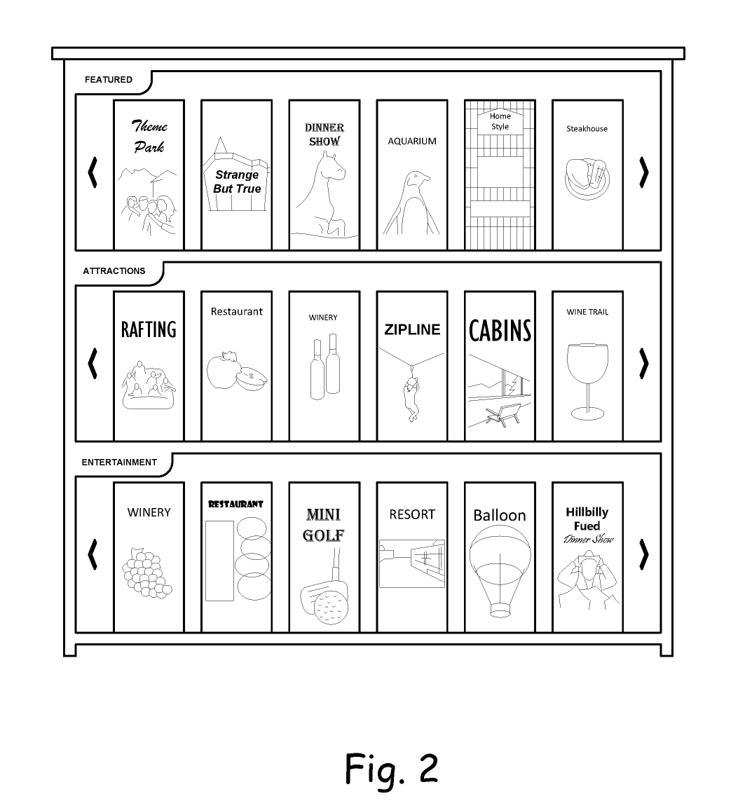

With reference now to the figures, there is depicted in FIG. 1 a first web page according to an embodiment of the present invention with virtual brochures arranged in three tiers and according to a first order. FIG. 2 depiction a second web page after the web page has been reloaded or otherwise refreshed, with the virtual brochures arranged in three tiers according to a second order. While the brochures have not moved from tier to tier, they have been rearranged within their tiers. In some instances a brochure that was visible in the first web page has been shuffled out of view, and a brochure that was not visible in the first web page has been shuffled into view. However, none of the brochures have migrated from one tier to another in the two different web pages.

In some embodiments the customer can access the brochures by selecting categories or other criteria, or can look at all of the brochures. When a customer clicks on a brochure and either looks at it or moves it to his saved collection, the information associated with that selection is tracked by the system 100. In some embodiments a button is provided so that the user can scroll through all brochures in a given tier. In some embodiments a button is provided so that the user can display all brochures at once within a given tier. In some embodiments the tiers include an indication of a category of brochure that is depicted on the tier, such as featured, attractions, entertainment, guides, accommodations, restaurants, outdoor, shopping, and so forth.

In some embodiments the system 100 performs geo-fencing, such as with a vicinity 108, as described in more detail hereafter. When a customer device 104 is enabled to report its location to the system 100, brochures for nearby business are placed on a separate brochure rack and organized according to distance. By looking at the geography based brochure rack, the customer can find nearby business. Also, the customer can search the nearby business using search terms such as “coffee,” and thereby find the nearby business that sell coffee.

In some embodiments the system 100 requests that the customer select a particular geographic area before it begins displaying brochures. The customer is also given the option of either looking at brochures or receiving a guided tour of the area. As the customer takes the tour of the area, which may be textually or graphically based, the customer is given the opportunity to click on brochures concerning businesses in the area.

Some embodiments include kiosks 106, such as in local welcome centers and hotels, that display the web pages. As a customer approaches the kiosk 106, the Bluetooth or other technology on the customer device 104, if enabled, can communicate with the kiosk 106. Customer devices 104 can include devices such as laptops, cell phones, and tablets. Thus, the customer can select various brochures at the kiosk 106 and add the brochures to his personal selection on his customer device 104 or elsewhere. In some embodiments those brochures also appear on other devices associated the customer.

The customer's device 104 may also be programmed to vibrate whenever the customer is within a selected distance from a particular business, such as by using the vicinity 108, as described in more detail hereafter.

In some embodiments, the system 100 acquires information such that it is able to monitor the geo-position of the customer device 104, and selectively displays brochures for the goods and services of clients that are within a given distance of the customer device 104. In some embodiments the system 100 sends to the customer device 104 a message for the customer in regard to the nearby businesses. In some embodiments the message is a discount coupon for the businesses, and in some embodiments the message is an advertisement.

In some embodiments the system 100 causes the customer device 104 to automatically text or email a proximal business when the customer arrives at or enters the business. In this manner, the business knows that the customer arriving at the business has viewed a brochure for the business, and perhaps has received an alert or coupon on his device 104. In some embodiments, the customer device 104 is detected at the entrance to the business. In some embodiments, the customer device 104 generates either an active or a passive signal, such as either a Bluetooth, near field communication, or RF ID signal, that is detected by a physical device at the entrance of the business 108. In this manner, the business can respond in some desired manner to the presence of a customer who has used the system 100. For example, the business can count the number of customers who enter the business and have used the system 100. In some embodiments, the customer device 104 emails or texts a message to the owners reporting that the customer device 104 went to the business, such as based on its GPS coordinate location system. In some embodiments the customer device 104 displays a message asking for customer consent to send the business a message such as a text, letting the business know that the customer is there.

In some embodiments, when the customer device 104 detects that it is near a particular business 108, it automatically begins transmitting a Bluetooth signal indicating its proximity. The Bluetooth signal is detectable over only a short distance, and in some embodiments is only generated when the location features on the customer device 104 indicated it was at a particular business 108. In some embodiments the process of generating the Bluetooth transmission as the customer walks into the business 108 is done entirely in the background, and the customer is not interrupted or disturbed as he enters the business 108. In some embodiments this only reports the customers presence, and only if he has saved a brochure advertising the particular business. In some embodiments both events of the entrance and the egress of the customer are tracked, along with the length of time that the customer spent within the business 108.

In some embodiments the tiering and shuffling of brochures is determined at least in part by proximity of the customer to the client businesses 108, based on geographical information. In some embodiments, the system 100 tiers and shuffles only a given number, such as ten, of the closest businesses. In some embodiments the ten closest businesses are determined using a GPS signal to determine the location of the customer device 104 and calculating the distances to the businesses using the customer device 104. In other embodiments the tiering and shuffling is based on a Bluetooth signal.

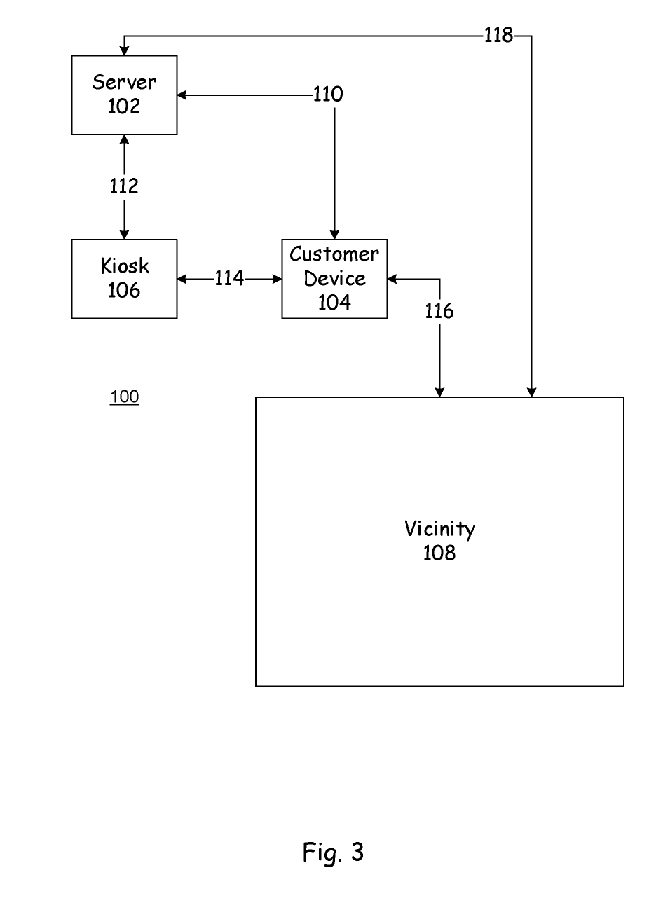

With reference now to FIG. 3 there is depicted a functional block diagram of a system 100 according to an embodiment of the present invention. The server 102 includes memory, both RAM and storage, a processor, and input/output capabilities. The virtual brochures as described above are stored on the server 102. The server 102 compiles web pages of brochures, which brochures are selected based at least upon the criteria as described herein, and also including without limitation elements such as search criteria as entered by the customer.

The server 102 provides the web pages to a customer device 104, through a connection 110. In some embodiments the connection 110 is the Internet or some other global network. The customer device 104 can be one or more of several different devices, such as a personal computer, a laptop, a tablet, a cell phone, and so forth. The customer can interact with the server 102 using the customer device 104, to refine the criteria for the selection of brochures that are presented on the web pages generated by the server 102, or for selecting brochures to move them to a personal storage area, residing either on the server 102 or on the customer device 104, to receive additional information in regard to a selected brochure, or to patch through the server 102 directly to a server operated by the client who's brochure the customer selected.

By selecting a given brochure, the customer user can invoke a number of different options, such as displaying the contents of the brochure, clicking through the website of the brochure's sponsor, saving the brochure to the customer's personal tier or storage area, or initiating a telephone call to the brochure's sponsor.

The customer can also interact with the server 102 through a kiosk 106, which communicates with the server 102 through connection 112, which in various embodiments is a global network such as the Internet or a dedicated communications link. In some embodiments the customer device 104 interacts with the kiosk 106, and thereby with the servers 102, through the connection 114. The connection 114 is, in various embodiments, a global network such as the Internet, a wireless cell phone signal, a near field communication signal, an infrared communication signal, an ad hoc wireless network connection, a Bluetooth connection, and so forth.

In some embodiments there are one or more vicinities 108 that are defined by the system 100. In one embodiment the vicinity 108 is defined by the signal strength of a communication link 116 that is generated by a client such as an infrared or Bluetooth signal within his business establishment. In another embodiment the vicinity 108 is defined as specific latitude and longitude boundaries on the server 102, which receives positioning information from the customer device 104, and determines when the customer device 104 has entered the defined boundary area. In another embodiment the vicinity 108 is defined by near field communication 116 between sensors in the vicinity 108 and the customer device 104. In another embodiment the vicinity is defined by passive RF ID sensors that detect the customer device 104.

In some embodiments, when the customer device 104 has been detected to be within the vicinity 108, the vicinity 108 alerts the server 102 through connection 118 to push specific information to the customer device 104 through connection 110. In some embodiments, when the customer device 104 has been detected to be within the vicinity 108, the vicinity 108 itself pushes specific information to the customer device 104, such as through connection 116.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A system for electronically presenting virtual brochures to a customer, the system comprising a server having:
a memory for holding information relating to the brochures,
a processor for creating a page of selected brochures, the processor arranging the brochures in tiers on the page, and selectively shuffling an order of the brochures within the tiers upon occurrences of creating the page, and
an output for sending the created page to a device of a customer.

2. The system of claim 1, wherein the processor selects the brochures for the created page based at least in part upon a location of the device.

3. The system of claim 1, wherein the processor selects the brochures for the created page based at least in part upon a category of brochures selected by the customer.

4. The system of claim 1, wherein the processor selects the brochures for the created page based at least in part upon a service level paid for by a brochure sponsor.

5. The system of claim 1, wherein the processor selects the brochures for the created page based at least in part upon a history of brochures opened by the customer.

6. The system of claim 1, wherein the processor selects the tier in which a brochure is arranged based at least in part upon a service level paid for by a brochure sponsor.

7. The system of claim 1, further comprising the processor storing to the memory a number of occurrences that the customer has opened each one of the brochures.

8. The system of claim 1, further comprising the processor storing to the memory a length of time that the customer has viewed each one of the brochures.

9. The system of claim 1, further comprising the processor storing to the memory a location of the customer when the customer opened each one of the brochures.

10. The system of claim 1, wherein a first set of functions performed by the processor is performed by a first processor disposed in a remote server, and a second set of functions performed by the processor is performed by a second processor disposed in the device of the customer.

11. A processor-based method for electronically presenting virtual brochures to a customer, the method comprising the steps of:
selecting brochures from a memory with a processor, where each of the brochures has associated with it a tier,
in response to a first request, creating a first page of the brochures, by arranging the brochures on the first page according to their associated tier, and in a first order within the tiers,
in response to a second request, creating a second page of the brochures, by arranging the brochures on the second page according to their associated tier, and in a second order within the tiers, where the second order is different from the first order, and
sending the pages as requested to a device of a customer.

12. The method of claim 11, wherein the step of selecting the brochures for the created page is based at least in part upon a location of the device.

13. The method of claim 11, wherein the step of selecting the brochures for the created page is based at least in part upon a category of brochures selected by the customer.

14. The method of claim 11, wherein the step of selecting the brochures for the created page is based at least in part upon a service level paid for by a brochure sponsor.

15. The method of claim 11, wherein the step of selecting the brochures for the created page is based at least in part upon a history of brochures opened by the customer.

16. The method of claim 11, wherein the step of selecting the tier in which a brochure is arranged is based at least in part upon a service level paid for by a brochure sponsor.

17. The method of claim 11, further comprising the step of storing to the memory a number of occurrences that the customer has opened each one of the brochures.

18. The method of claim 11, further comprising the step of storing to the memory a length of time that the customer has viewed each one of the brochures.

19. The method of claim 11, further comprising the step of storing to the memory a location of the customer when the customer opened each one of the brochures.

20. A software program disposed on a non-volatile medium, the program operable to enable a computing device to electronically present virtual brochures to a customer, by:
selecting brochures from a memory with a processor, where each of the brochures has associated with it a tier,
in response to a first request, creating a first page of the brochures, by arranging the brochures on the first page according to their associated tier, and in a first order within the tiers,
in response to a second request, creating a second page of the brochures, by arranging the brochures on the second page according to their associated tier, and in a second order within the tiers, where the second order is different from the first order, and
sending the pages as requested to a device of a customer.
